(19) United States
(12) Patent Application Publication
(10) Pub. No.: US 2009/0283989 A1
(43) Pub. Date: Nov. 19, 2009

(54) Shopping-Cart With Removable Compartments

(76) Inventor: Yehouda Abecassis, Ashdod (IL)

Correspondence Address: The Law Office of Michael E. Kondoudis, 888 16th Street, N.W., Suite 800, Washington, DC, 20006, US

(21) Appl. No.: 12/119,598

(22) Filed: May 13, 2008

(51) Int. Cl. B62B 3/02

(52) U.S. Cl. 280/651; 280/47.35

(57) ABSTRACT

A cart having a cart-frame that includes: an upper frame-portion enabling a user to hold the portion in order to push the cart; a base frame-portion comprising wheels connected to the base frame-portion enabling the cart to roll through the wheels; and connectors connecting the base frame-portion to the upper frame-portion and supporting the upper frame-portion's weight. The upper frame-portion may include compartment-installation structures enabling the user to add and remove compartments according to his desire and needs. The compartments may be selectively removed and installed.

### FIELD OF THE INVENTION

The present invention, in some embodiments thereof, generally relates to the field of shopping-carts and more particularly to shopping-carts comprising a multiplicity of compartments.

### BACKGROUND

Shopping-carts such as trolleys, for example, are usually designed to carry a multiplicity of products in a single compartment, where the trolleys usually comprise wheels to allow easy and comfortable moving of the products within the cart without having to carry their entire weight.

Many shops and supermarkets provide trolleys to their customers, where a customer may use the trolley while selecting products at the supermarket and then for carrying the products from the supermarket to the vehicle's trunk, for example, where the customer may be required to empty the content of the trolley into the trunk in order to return the trolley.

Most shopping carts comprise a single compartment for containing the products, which may be substantially big to allow containing a substantial amount of products. Additionally, when shopping, some products may be best to be kept as far as possible in the cart from other products, for example cold and frozen food products. This may become quite a cumbersome task when walking down the supermarket's passageways.

### SUMMARY OF SOME EMBODIMENTS OF THE INVENTION

The present invention, in some embodiments thereof, provides a cart that may be used as a shopping cart, for example, that may comprise a cart-frame able to carry a multiplicity of compartments, where each compartment may be removable—allowing a user to remove or add compartments to the frame, according to the user's desire and the cart's predefined compartment sizes and number.

According to some embodiments of the invention, the cart-frame may comprise an upper frame-portion enabling a user to hold the upper frame-portion in order to push the cart; a base frame-portion comprising wheels connected to the base frame-portion enabling the cart to roll through the wheels; and one or more connectors enabling to connect the base frame-portion to the upper frame-portion and support said upper frame-portion's weight.

The upper frame-portion may comprise compartment-installation structures enabling the user to add and remove compartments permitting the selective installation and removal of a compartment where the structures enable removing and re-adding compartments to the cart according to the user's desire.

The upper frame-portion may comprise a grabbing-member enabling the user to grab the grabbing-member when pushing the cart and at least two substantially parallel compartment-holders each connected to the grabbing-member, where the compartment-holders enable holding at least one compartment.

According to some embodiments of the invention, each compartment-holder may comprise slits, which are the compartment-installation structures, created at predefined positions along each compartment-holder, where each compartment may comprise a protruding member enabling to slide into the slits whereby the compartments may be held.

Additionally, the base frame-portion may comprise:
at least two back-wheels and at least two front-wheels enabling the cart to roll, where each pair of front-wheel—and back-wheel may be connected to one another through a base side-connector, where one side-connector is substantially parallel to the other connector; and
a back and a front base-supports enabling to connect the base side-members to one another enabling the final structure of the base frame-portion to provide a substantially proper support and balancing to the weight of the cart the cart's expected content.

Additionally, the connectors may comprise at least two front-supports that are substantially parallel to one another and at least two back-supports that may also be substantially parallel to one another. The top end of each front-support may be connected to the adjacent compartment holder of the upper frame-portion and the bottom end of each front-support may be connected to the adjacent base side-member of the base frame-portion. The top end of each back-support may be connected to the adjacent compartment holder of the upper frame-portion and the bottom end of each back-support may be connected to the adjacent base side-member of the base frame-portion.

Additionally, at least one grabbing-pad may be attached to the grabbing-member, where each grabbing-pad may be made from soft materials such as rubber, fabric and the like to provide the user with a pleasant tactile sensation while pushing the cart.

According to some embodiments of the invention, the compartment-installation structures may be separate fasteners allowing the user to fasten the compartments to the compartment-holders at any desirable position along the compartment-holders.

According to some embodiments of the invention, the compartments may be made from solid materials such as solid plastic, glass and the like, to allow containing of predefined volumes. Alternatively, the compartments may be made from flexible materials such as fabric or flexible polyester materials to allow folding the compartments into a compacted position.

According to some embodiments of the invention, the side-members of the base frame-portion may connect to the front support and the back supports of the connectors through joint-hinges enabling to fold the base frame-portion towards the connectors. Additionally, the upper frame-portion may connect to the back-supports through joint-hinges to allow rotating the upper frame-portion and folding the upper frame-portion towards the connectors. Additionally or alternatively, the top end of the curved front-supports may be connected to the compartment-holders in a way that enables detaching said front-supports from the compartment-through detaching means enabling to fasten the front-supports top ends to the holders for opening of the cart-frame and detach them to fold said frame.

Additionally, the front wheels and the back wheels may also enable folding to further allow compacting the entire cart to a folded position. The wheels may be connected to the base side-connectors through bearings, hinges or both, for example, to enable the folding.

According to some embodiments of the invention, the compartment-holders may be telescopic enabling the user to adjust the length of the compartment-holders to enable the user to add more compartments in an open position of the telescopic compartment-holders and to allow shortening the length of the compartment-holders when less compartments are required.

The forgoing other aspects will become apparent from the following detailed description when considered in conjunction with the accompanying figures.

### BRIEF DESCRIPTIONS OF THE DRAWINGS

The subject matter regarded as the invention will become more clearly understood in light of the ensuing description of embodiments herein, given by way of example and for purposes of illustrative discussion of embodiments of the present invention only, with reference to the accompanying drawings, wherein:

FIG. 1 is a schematic illustration of an isometric view of a shopping cart, according to some embodiments of the invention;

FIG. 2 is a schematic illustration of an isometric view of a shopping cart in a folded position, according to some embodiments of the invention;

FIG. 3 is a schematic illustration of a side view of a shopping cart with telescopic compartment holders, according to some embodiments of the invention; and

FIG. 4 is a schematic illustration of an isometric view of a shopping cart with telescopic compartment holders, according to some embodiments of the invention.

The drawings together with the description make apparent to those skilled in the art how the invention may be embodied in practice.

### DETAILED DESCRIPTIONS OF SOME EMBODIMENTS OF THE INVENTION

The present invention, in some embodiments thereof, provides a cart 100 such as, for example, a shopping-cart 100, a trolley or a cart 100 as a home-furniture that is movable by wheels.

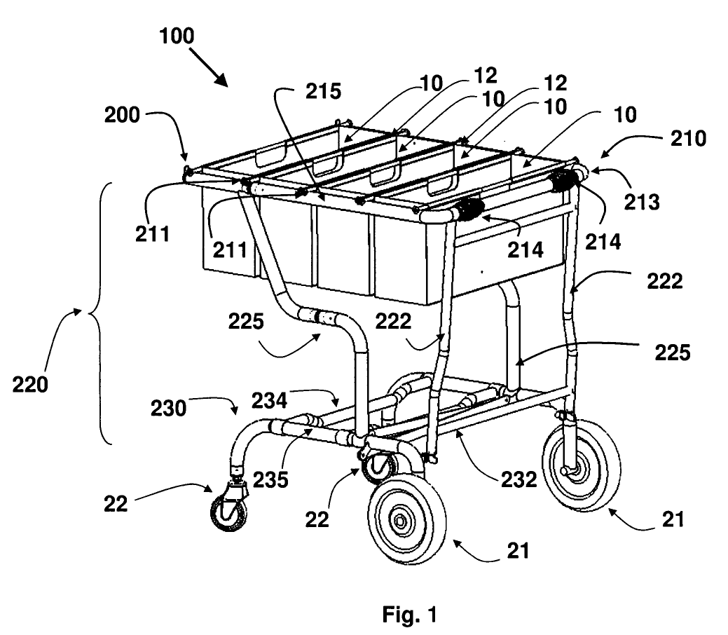

According to some embodiments of the invention, as illustrated in FIG. 1, the cart 100 may comprise a cart-frame 200 comprising an upper frame-portion 210 and a base frame-portion 230 connected to one another through connectors 220. The connectors 220 may interconnect the base frame-portion 230 and the upper frame-portion 210 thereby supporting the weight of the upper frame-portion 210.

The upper frame-portion 210 may be holdable by a user in order to transfer a pushing force to the cart-frame 200. The upper frame-portion 210 may have a multiplicity of compartment installation structures 211 each permitting the selective installation and removal of compartments from and to the cart 100. The base frame-portion 230 may have wheels 21 and 22 operatively connected thereto and on which the cart-frame 200 rolls in response to the pushing force applied by the user.

The upper frame-portion 210 may comprise compartment-installation structures such as slits 211, for example, enabling a user to add and remove removable compartments 10 from the upper frame-portion 210 according to the user's desire and needs. The structures 211 may permit the selective installation and removal of a compartment.

Adding and removing compartments 10 may enable the user to:
(1) use different compartments 10 for different products while shopping;
(2) adjust the number of compartments 10 based on the amount of products bought;
(3) store the products in the compartments 10 without having to take them out of the compartments 10 to carry them in the vehicle, for example.

The cart 100 may be used for other purposes than shopping, for example in airports as a trolley for bags enabling adding compartments 10 of different sizes according to bags' sizes (e.g. hand bag, suitcase etc.) or as movable furniture for a kitchen, for example.

While the description below contains many examples, these should not be construed as limitations on the scope of the invention, but rather as exemplifications of some embodiments. It is to be understood that possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the invention. It is understood that the phraseology and terminology employed herein is not to be construed as limiting and are for descriptive purpose only.

The principles and uses of the embodiments of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

FIG. 1 schematically illustrates a cart 100 with a multiplicity of compartments 10 added to it, according to some embodiments of the invention. The cart-frame 200 may comprise:
an upper frame-portion 210;
a base frame-portion 230; and
connectors 220 enabling to connect the base frame-portion 230 to the upper frame-portion 210 and support the upper frame-portion's 210 weight.

According to some embodiments of the invention, the upper frame-portion 210 may comprise a grabbing-member 213 enabling the user to grab the grabbing-member 213 to push the cart 100; and at least two substantially parallel compartment-holders 215 enabling to hold at least one compartment 10, where the compartment-holders 215 may be connected to or jointly configured to the grabbing-member 213. The compartment-holders 215 may comprise a plurality of compartment-installation structures 211 such as, for example, slits that allow sliding protruding members 12 of the compartments 10 into the slits whereby the compartments may be held by the upper frame-portion 210. The slits' positions may vary according to different designs of the cart 100. The positioning of the slits may enable, for example, compartments 10 of different sizes to be added to the frame 200, predefining the distances between the slits according to the pre-adapted compartments 10 to be installed.

According to other embodiments of the invention, the compartment-installation structures 211 may not require predefining the distances between the compartments 10 and/or the compartments' 10 sizes. For example, the compartment-holders 215 of the upper frame-portion 210 may be two rods where the compartment-installation structures 211 may be separate fasteners enabling to fasten the compartments 10 at any desirable position along the rods. Alternatively, the compartments may comprise sleeve like parts enabling to slide the sleeves along each side of the rod-shaped compartment-holders 215 whereby the rods may be threaded.

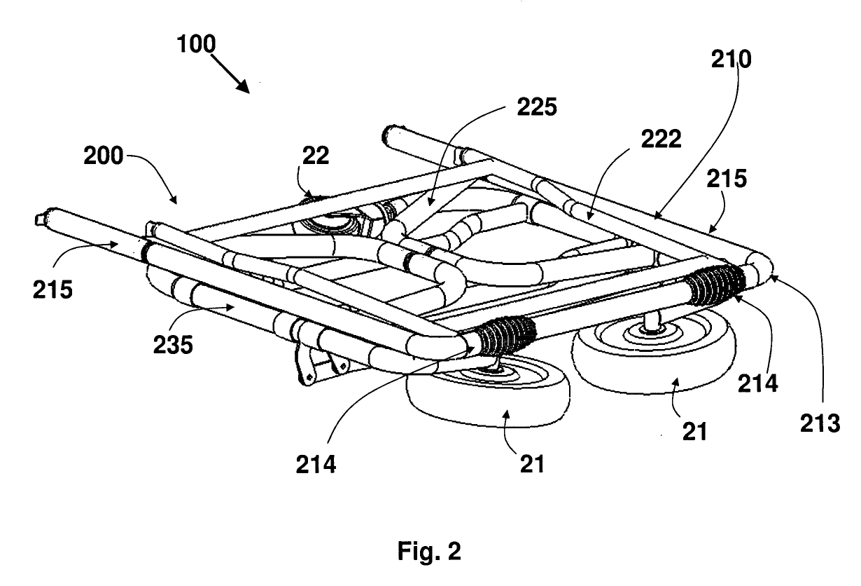

Additionally, according to embodiments as illustrated in FIG. 1 and FIG. 2, the base frame-portion 230 may comprise two back-wheels 21 and two front-wheels 22 enabling the cart 100 to roll, where each pair of a front-wheel 22 and a back-wheel 21 may be connected to one another through a base side-connector 235 where one pair may be substantially parallel to the other pair. The base frame-portion 230 may further comprise a back and a front base-supports 232 and 234 respectively, enabling to connect the base side-members 235 to one another enabling the final structure of the base frame-portion 230 to provide a substantially proper support and balancing to the weight of the cart 100 and its expected content.

Additionally, according to embodiments as illustrated in FIG. 1 and FIG. 2, the connectors 220 may comprise at least two curved front-supports 225 that may be substantially parallel to one another and at least two back-supports 222 that may also be substantially parallel to one another. The top end of each curved front-support 225 may be connected to the adjacent compartment holder 215 of the upper frame-portion 210 and the bottom end of each curved front-support 225 may be connected to the adjacent base side-member 235 of the base frame-portion 230. The top end of each back-support 222 may be connected to the adjacent compartment holder 215 of the upper frame-portion 210 and the bottom end of each back-support 222 may be connected to the adjacent base side-member 235 of the base frame-portion 230.

Additionally, at least one grabbing-pad 214 may be attached to the grabbing-member 213. The grabbing-pad 214 may be made from soft materials to provide the user with a pleasant feel when grabbing the grabbing-member 213 to push the cart 100.

According to some embodiments of the invention, the compartments 10 may be made from solid materials such as plastic, for example, to allow containing of predefined volumes.

According to alternative embodiments, the compartments 10 may be made from soft materials such as, for example, fabric, flexible plastic (e.g. plastic bags' material), or any other flexible material that allows folding the compartments in a compacted manner.

According to some embodiments of the invention, the cart-frame 200 may be compacted into a “folded position”, as illustrated in FIG. 2, allowing a compact storage of the cart 100 in the trunk, for example.

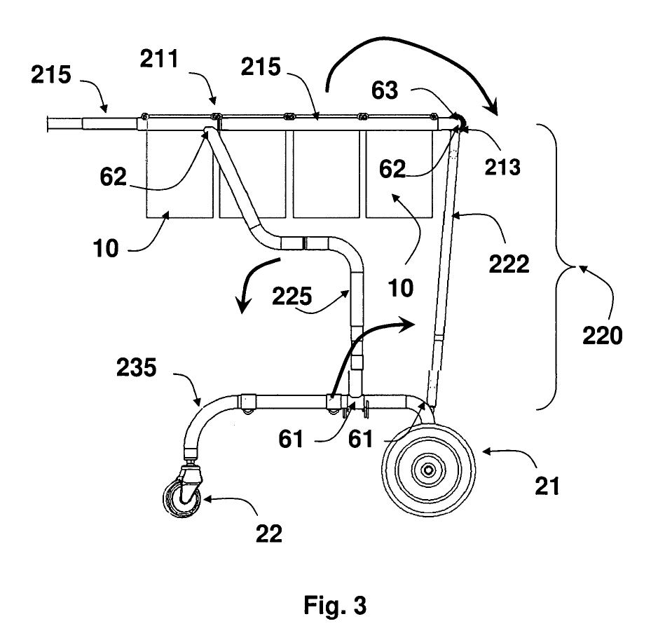

According to some embodiments of the invention, to enable folding of the frame 200 the side members 235 of the base frame-portion 230 may connect to the front support 225 and the back supports 222 of the connectors 220 through joint-hinges 61 enabling to fold the base frame-portion 230 towards the connectors 220, as illustrated in FIG. 3. Similarly, to fold the grabbing-member 213 towards the back-supports 222 as illustrated in FIG. 3, the upper frame-portion 210 may connect to the back-supports 222 through joint-hinges 63 to allow rotating the upper frame-portion 210 towards the connectors 220.

Additionally, the curved front-supports' 225 top ends may enable detaching from the compartment-holders 215 where their connection 62 to holders 215 may comprise detaching means enabling to fasten the curved front-supports' 225 top ends to the holders 215 for opening the frame 200 and detach them to fold the frame 200.

Additionally, the wheels 21 and 22 may also be connected to the side members 235 through bearings or hinges that may also allow folding of the wheels 21 and 22 into a folded position as illustrated in FIG. 2.

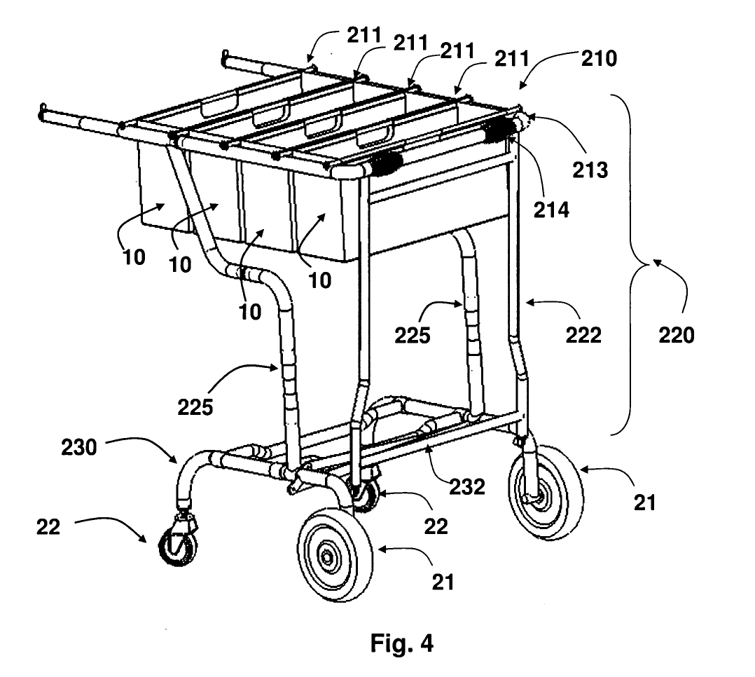

Additionally or alternatively, as illustrated in FIG. 3 and FIG. 4, according to embodiments of the invention, the compartment holders 215 may be telescopic, enabling length adjustment according to the number and/or sizes of the compartments 10 the user may wish to add to the cart 100. The user may adjust the length of the compartment-holders 215 to enable adding more compartments 10 in an open position of the telescopic compartment-holders 215.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A cart comprising a cart-frame, said frame comprising:
an upper frame-portion enabling a user to hold said portion in order to push said cart;
a base frame-portion comprising wheels connected to said base frame-portion enabling the cart to roll through said wheels; and
at least one connector enabling to connect the base frame-portion to the upper frame-portion and to support said upper frame-portion's weight;
wherein said upper frame-portion comprises compartment-installation structures enabling the user to add and remove compartments, and wherein said compartments are removable containing means enabling to be removed and re-added to said cart according to the user's desire.

2. The cart of claim 1, wherein said upper frame-portion comprises a grabbing-member enabling the user to grab the grabbing-member when pushing said cart and at least two substantially parallel compartment-holders each connected to said grabbing-member, wherein said holders enable holding at least one compartment.

3. The cart of claim 2, wherein each compartment-holder comprises slits, which are the compartment-installation structures, created at predefined positions along each compartment-holder, wherein each compartment comprises a protruding member enabling to slide into said slits whereby the compartments are held.

4. The cart of claim 3, wherein said base frame-portion comprises:
at least two back-wheels and at least two front-wheels enabling the cart to roll, wherein each pair of front-wheel—and back-wheel is connected to one another through a base side-connector, wherein one side-connector is substantially parallel to the other connector; and
a back and a front base-supports enabling to connect the base side-members to one another enabling the final structure of the base frame-portion to provide a substantially proper support and balancing to the weight of the cart the cart's expected content.

5. The cart of claim 4, wherein said connectors comprise at least two front-supports that are substantially parallel to one another and at least two back-supports that are also substantially parallel to one another, and
wherein the top end of each front-support is connected to the adjacent compartment holder of the upper frame-portion and the bottom end of each front-support is connected to the adjacent base side-member of the base frame-portion the top end of each back-support is connected to the adjacent compartment holder of the upper frame-portion and the bottom end of each back-support is connected to the adjacent base side-member of the base frame-portion.

6. The cart of claim 2, wherein at least one grabbing-pad is attached to said grabbing-member, wherein said pad is made from soft materials.

7. The cart of claim 2, wherein said compartment-installation structures are separate fasteners allowing the user to fasten the compartments to the compartment-holders at any desirable position along said holders.

8. The cart of claim 1, wherein said compartments are made from solid materials to allow containing of predefined volumes.

9. The cart of claim 1, wherein said compartments enable folding to allow compact storage of said compartments, when removed from said cart.

10. The cart of claim 9, wherein said compartments are made from flexible materials to allow folding of said compartments to compacted sizes.

11. The cart of claim 5 wherein:
said side-members of the base frame-portion connects to the front support and the back supports of the connectors through joint-hinges enabling to fold the base frame-portion towards the connectors;
said upper frame-portion connects to the back-supports through joint-hinges to allow rotating the upper frame-portion and folding said portion towards the connectors; and
the top end of the curved front-supports are connected to the compartment-holders in a way that enables detaching said front-supports from the compartment-through detaching means enabling to fasten the front-supports top ends to the holders for opening of the cart-frame and detach them to fold said frame.

12. The cart of claim 11, wherein said front wheels and back wheels also enable folding to further allow compacting the entire cart to a folded position.

13. The cart of claim 2, wherein said compartment-holders are telescopic enabling the user to adjust the length of said holders to enable the user to add more compartments in an open position of said telescopic compartment-holders.

14. A cart frame comprising:
an upper frame-portion that is holdable by a user in order to transfer a pushing force to the cart frame, the upper frame-portion having a multiplicity of compartment installation structures each permitting the selective installation and removal of compartments;
a base frame-portion having wheels connected thereto and on which the cart frame rolls in response to the pushing force; and
at least one connector interconnecting the base frame-portion and the upper frame, the connector supporting a weight of the upper frame.
